(19) United States
(12) Patent Application Publication
(10) Pub. No.: US 2008/0131225 A1
(43) Pub. Date: Jun. 5, 2008

(54) PROTECTION MEMBER

(75) Inventor: Gregory A. Payne, Plymouth, IN (US)

Correspondence Address: BAKER & DANIELS LLP, 202 South Michigan Street, Suite 1400, South Bend, IN, 46601, US

(73) Assignee: American Containers, Inc., Plymouth, IN (US)

(21) Appl. No.: 11/871,242

(22) Filed: Oct. 12, 2007

Related U.S. Application Data
(60) Provisional application No. 60/851,200, filed on Oct. 12, 2006.

(51) Int. Cl. B60P 7/06

(52) U.S. Cl. 410/34

(57) ABSTRACT

The invention relates to a corner protector of a window having a frame with an integral flange. The corner protector comprises a plurality of corrugated layers. The corrugated layers form two portions. A first portion is configured to be attached to a first portion of a window frame. A second portion is configured to be attached to a second portion of a window frame, wherein a corner is located intermediate the first portion and the second portion of the window frame. A free portion of the first portion of the member extends beyond the corner and overlaps the second portion of the member.

### BACKGROUND OF THE INVENTION

1. Field of the Invention

The present invention relates in general to dunnage utilized in the storage and shipping of goods. In particular, the present invention relates to packing materials configured to protect the corners of goods, such as windows.

2. Description of the Related Art

The shipping of goods, such as windows, often requires the utilization of protective mechanisms in order to protect the outer surface of the goods from damage that may occur during shipping and storage. Accordingly, various protective mechanisms have been developed in the art to protect goods during shipping.

It is known in the art to utilize multiple protective members in order to protect the corners of an item during shipment. For example, while shipping a window having a rectangular profile, it is known in the art to utilize eight separate members made from a material capable of absorbing impact forces in order to protect the corner of the window. Generally, two members are attached to a side of a window adjacent to the corners of the window frame. In this manner, the members encompass the corner and provide a mechanism for absorbing impact forces in the corner area.

FIG. 1 depicts a prior art protection member 10 configured to protect a window 12. Protection member 10 encompasses a corner 14 of window 12 and includes a first component 16 and a second component 18. Each of the components 16, 18 include a plurality of corrugate layers, each indicated by number 20. The corrugated layers 20 may be manufactured from a paper product, such as cardboard. The components 16, 18 share a common web 22 defining an underside mating surface (not shown). The mating surface includes a slot (not shown) configured to receive a flange (not shown) formed in a frame 24 of the window 12. In the prior art, the attachment of protection member 10 to the flange of the frame 24 forms a gap 26 in member 10. The alignment of the gap 26 with the corner of the flange may fail to provide adequate protection to the frame 24 if a person carrying the window 12 were to drop the window 12 on the corner 14. For example, if a handler accidentally dropped the window 12, a force, indicated by arrow 28, may be of sufficient magnitude to damage the frame 24 at corner 14.

### SUMMARY OF THE INVENTION

The present invention relates to a member for protecting a corner of a window having a frame. The member includes first and second portions each comprising a plurality of protective sheets. The first portion may be arranged on a first side of the window frame, and the second portion may be arranged on a second side of the window frame. An intermediate member connects the first portion to the second portion. In embodiments of the invention, a portion of the first portion overlaps the second portion when the member is attached to the window.

In embodiments of the invention, the member comprises a plurality of corrugated sheets. The corrugated sheets may be manufactured from any suitable material, such as paper or plastic.

In embodiments of the invention, the member may include a slot capable of receiving a flange formed on the window frame. In addition, one of the protective sheets may include a bend defining a first portion of the protective sheet and a second portion of the protective sheet. The second portion of the protective sheet may form the intermediate member connecting the first portion of the member to the second portion of the member.

The present invention may also comprise a method of manufacturing a protective member. The method may comprise the steps of affixing a plurality of corrugated sheets together to form an upper section; affixing at least one lower sheet to the upper section in a manner ensuring a central portion of the lower sheet is free from a central portion of the upper section; and cutting the upper section at substantially the center of the central portion.

The method may further comprise the step of cutting a slot in the underside of the lower sheet. In embodiments of the invention, the slot may extend into the upper section.

In embodiments of the invention, the method filter comprises the steps of cutting the upper section and the lower section in a manner forming a first side; cutting the upper section and the lower section in a manner forming a second side; cutting the upper section and the lower section in a manner forming a first outside face; and cutting the upper section and the lower section in a manner forming a second outside face. The method may further comprise the step of bending the lower section at a position proximate the edge of the unattached central portion.

### BRIEF DESCRIPTION OF THE DRAWINGS

The above-mentioned and other features of this invention and the manner of obtaining them will become more apparent and the invention itself will be better understood by reference to the following description of an embodiment of the present invention taken in conjunction with the accompanying drawings, wherein:

FIG. 1 depicts a perspective view of prior art protective member coupled to a window frame;

FIG. 2 depicts a perspective view of a protective member of the present invention;

FIG. 3 depicts a side view of the protective member depicted in FIG. 2;

FIG. 4 depicts a bottom view of the protective member depicted in FIG. 2;

FIGS. 5 through 11 depict the steps of assembling the protective member depicted in FIG. 2; and

FIG. 12 depicts a perspective view of the protective member depicted in FIG. 2 protecting the corner of the window.

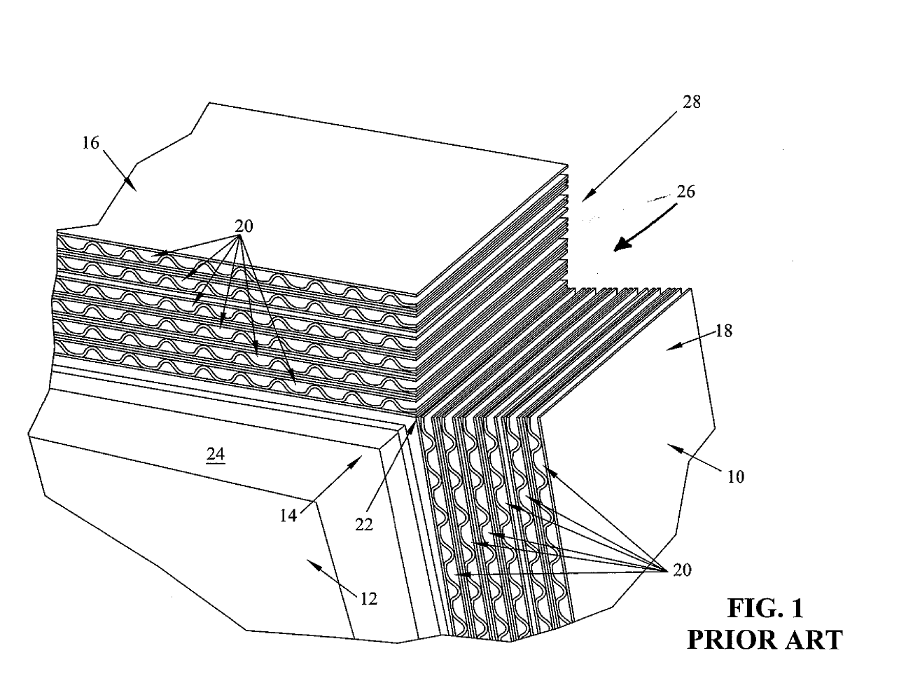

Although the drawings represent an embodiment of various features and components according to the present invention, the drawings are not necessarily to scale and certain features may be exaggerated in order to better illustrate and explain the present invention. The exemplification set out herein illustrates an embodiment of the invention, and such exemplification is not to be construed as limiting the scope of the invention in any manner.

### DETAILED DESCRIPTION OF AN EMBODIMENT OF THE INVENTION

For the purposes of promoting an understanding of the principles of the invention, reference will now be made to the embodiment illustrated in the drawings, which is described below. It will nevertheless be understood that no limitation of the scope of the invention is thereby intended. The invention includes any alterations and further modifications in the illustrated device and described method and further applications of the principles of the invention, which would normally occur to one skilled in the art to which the invention relates. Moreover, the embodiment was selected for description to enable one of ordinary skill in the art to practice the invention.

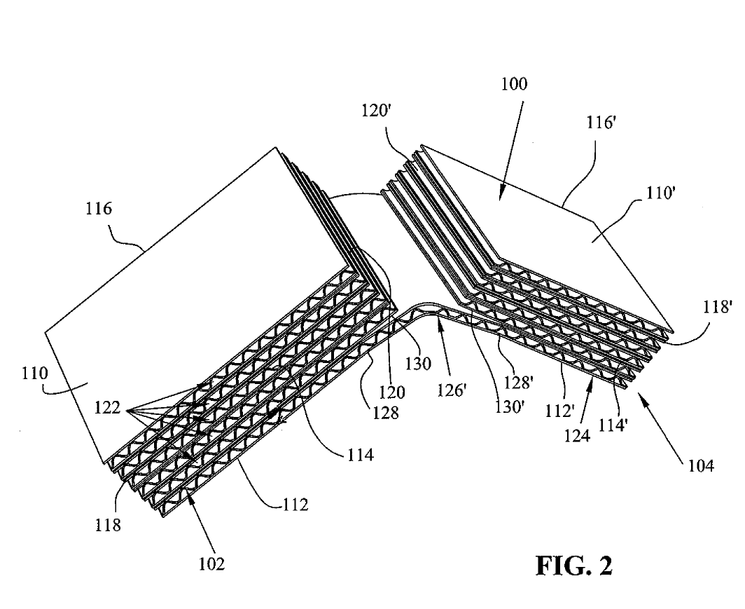

FIG. 2 depicts a perspective view of an embodiment of the present invention comprising a protective member, generally indicated by numeral 100. In the present embodiment of the invention, protective member 100 comprises a plurality of corrugated sheets 122, 124 fixed together. For example, in embodiments of the invention, the corrugated sheets 122, 124 may be manufactured from paper products, such as cardboard. In other embodiments of the invention, the corrugated sheets 122, 124 may be manufactured from any suitable material, such as plastic. Similarly, the corrugated sheets 122, 124 may be affixed together in any suitable manner. For example, the plurality of sheets 122, 124 comprising protective member 100 may be affixed together with any suitable adhesive.

In the present embodiment of the invention, protective member 100 includes a first portion, generally indicated by numeral 102, and a second portion, generally indicated by numeral 104. First portion 102 and second portion 104 have substantially similar configurations and in the depicted embodiment are mirror images. Thus, for the sake of brevity, only first portion 102 will be described in detail herein.

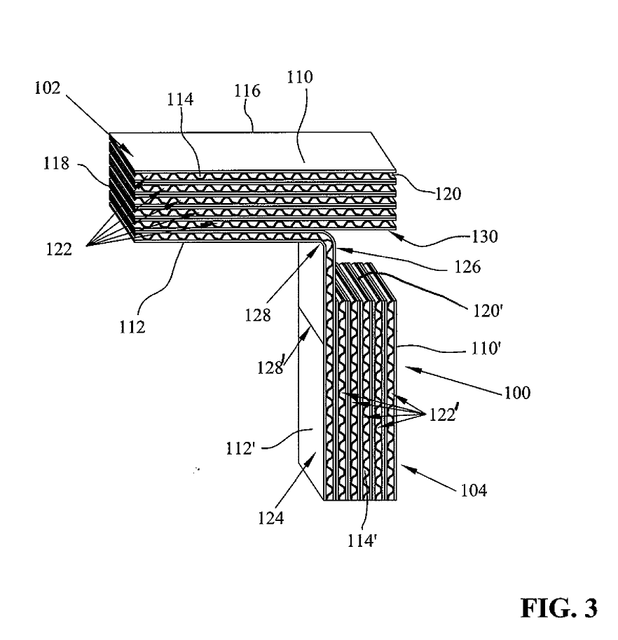

With reference to FIGS. 2 through 4, the depicted embodiment of the invention, first portion 102 includes a top surface 110, a bottom surface 112, a first face 114, a second face 116, an outside face 118 and an inside face 120. First portion 102 further comprises a plurality of upper sheets, each indicated by numeral 122 and a base sheet indicated by numeral 124. It should be noted that the number of sheets 122, 124 comprising the portion 102 may be altered as necessary for the intended purpose.

In the depicted embodiment of the invention, the upper sheets 122 each have substantially the same size and shape. As shown in FIG. 2, a common edge of the upper sheets 122 defines inside face 120. Similarly, the remaining edges of the upper sheets 122 in conjunction with edges of the base sheet 124 define the first face 114, the second face 116 and the outside face 118.

In the depicted embodiment of the invention, the base sheet 124 interconnects the first portion 102 with the second portion 104. Moreover, the base sheet 124 is coupled to the lower most upper sheet 122 in a known manner, such as by way of an adhesive, for example. It should be noted in the depicted embodiment, a majority of the upper base sheet 124 is coupled to the lowest of the upper sheets 122, but a free portion 126 of the base sheet 124 is not coupled to any of the upper sheets 122. In the depicted embodiment of the invention, a bend, generally indicated by numeral 128, separates the free portion 126 from the remainder of the base sheet 124. Similarly, bend 128 defines a free portion, indicated by numeral 130, in upper sheets 122.

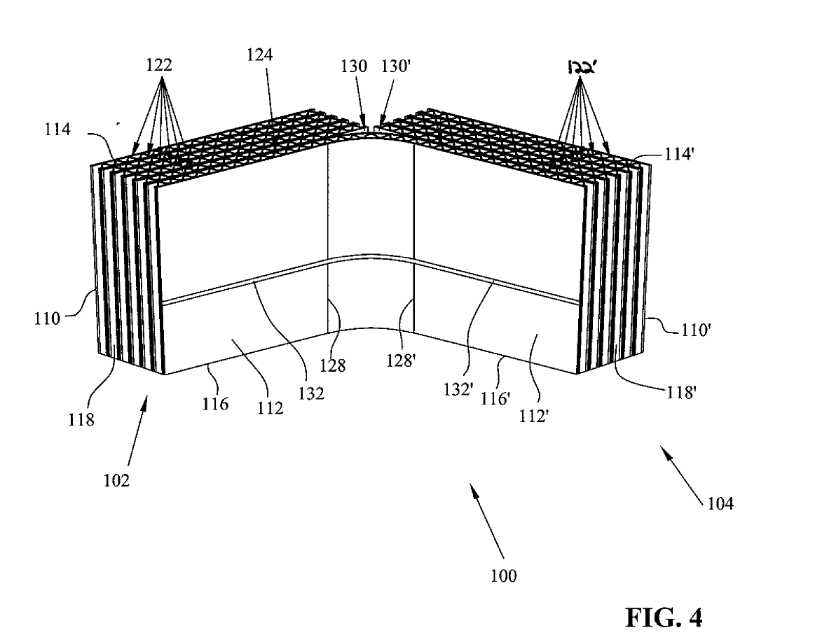

With reference specifically to FIG. 4, a suitable number of sheets 122, 124 include a slot generally indicated by numeral 132. In embodiments of the invention, the slot 132 extends through the base sheet 124 and may extend into upper sheets 122, as necessary, for proper utilization of the member 100.

The second portion 104 has substantially the same structure as that of first portion 102. Specifically, second portion 104 includes a top surface 110′, a bottom surface 112′, a first face 114′, a second face 116′, an outside face 118′ and an inside face 120′. Second portion 104 further comprises a plurality of upper sheets 122′. The upper sheets 122′ of second portion 104 are affixed to the base sheet 124 that interconnects the first portion 102 with the second portion 104. In a manner similar to first portion 102, second portion 104 includes a free portion 126′ of the base sheet 124. Similarly, a bend 128′ defines a free portion 130′ in the lower most of the upper sheets 122′.

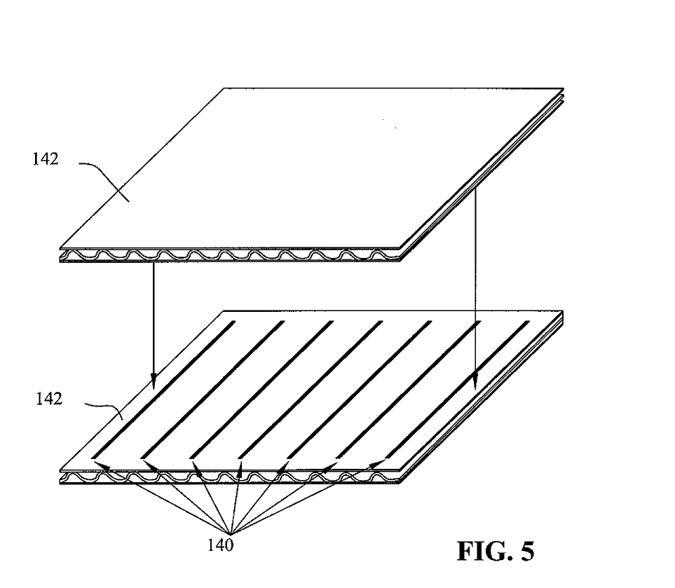

Now that the structure of protective member 100 has been described, a method of assembling an embodiment of a protective member 100 will now be described with reference to FIGS. 5 through 11. It should be noted that the embodiment of the protective member 100 being described results in two base sheets 124. In order to assemble protective member 100, strips of adhesive, each generally indicated by numeral 140, couples together lower sheets of material, each generally indicated by numeral 142. In embodiments of the invention, any suitable manner of attaching the sheets may be employed. In the embodiment depicted, the strips of adhesive 140 couples substantially all of the mating surfaces of the lower sheets 142 together.

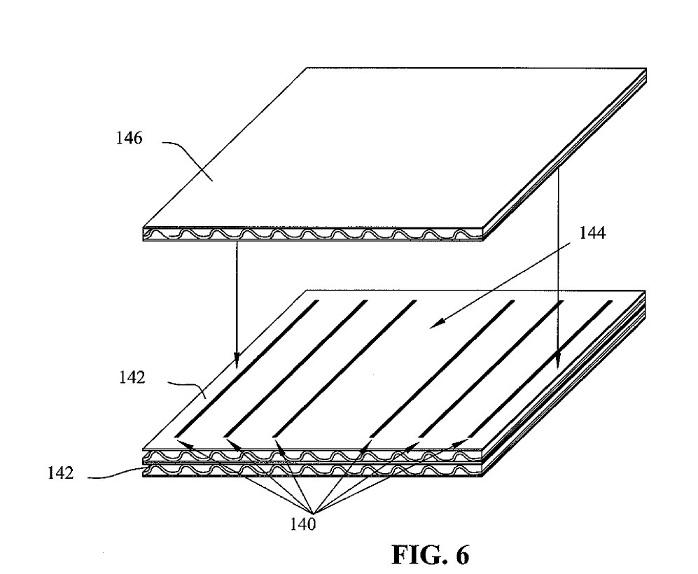

Once the lower sheets 142 have been joined, strips of adhesive 140 may be added to the top surface of the outer portions of the joined lower sheets 142, similar to that described previously. In this instance, however, one or more strips previously added to the material may not be used. In the depicted embodiment, strips of adhesive 140 are not applied to the center of the sheet 142. The lack of adhesive 140 proximate the center of the sheet 142 defines a free area, generally indicated by numeral 144, as shown in FIG. 6. An intermediate sheet 146 may then be placed onto the collective lower sheets 142.

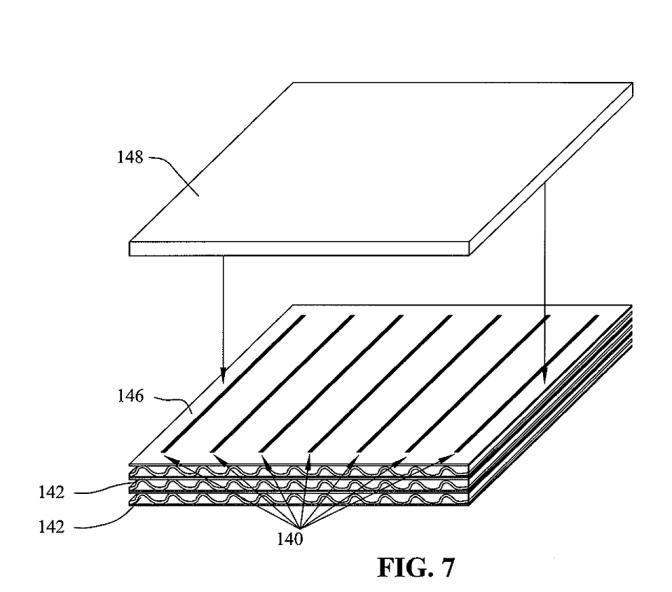

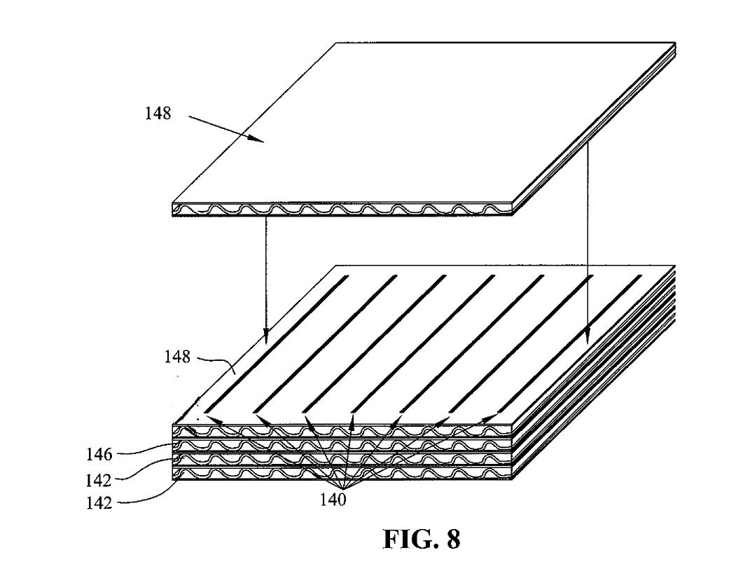

As shown in FIG. 7, strips of adhesive 140 may then be spread across the entire upper surface of the intermediate sheet 146, as described above, in order to affix upper sheet 148 to be affixed to the intermediate sheet 146. In addition, strips of adhesive 140 may be utilized to affix additional upper sheets 148 together, as depicted in FIG. 8, in a similar manner.

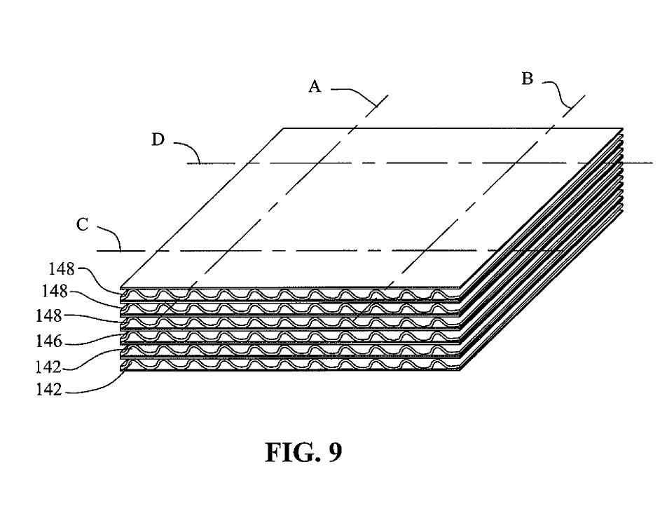

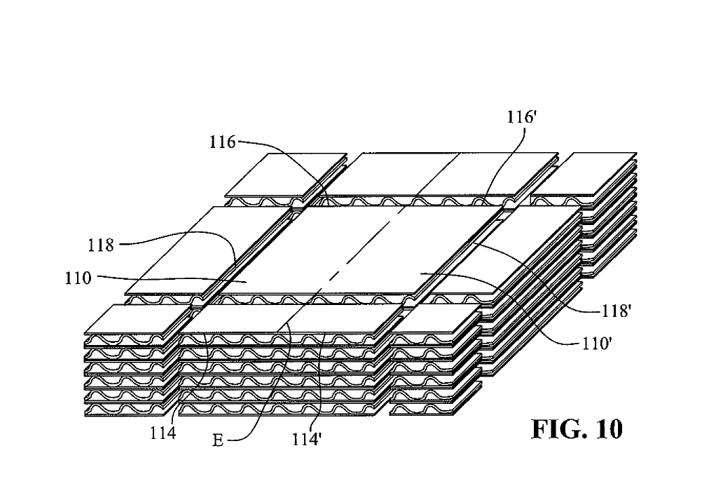

With reference to FIG. 9, once a sufficient number of upper sheets 148 have been added to the assembly and the adhesive has set, a conventional cutting mechanism may be utilized to make cuts indicated by lines “A,” “B,” “C” and “D.” With reference to FIGS. 9 and 10, the cut indicated by line “A” forms outside face 118 of member 100, and the cut indicated by line “B” forms outside face 118′. The cut indicated by line “C” forms the first faces 114, 114′, and the cut indicated by line “D” forms second faces 116, 116′. In the depicted embodiment of the invention, the cuts indicated by lines “A,” “B,” “C” and “D” extend through all of the lower sheets 142, the intermediate sheet 146 and the upper sheets 148.

With reference now to FIG. 10, an additional cut, made along the line indicated by “E”, is also made in the assembly. The cut indicated along the line indicated by “E” extends through only the intermediate sheet 146 and the upper sheets 148. In the depicted embodiment of the invention, the cut made along line “E” is located at approximately the center of the free area 144 depicted in FIG. 6.

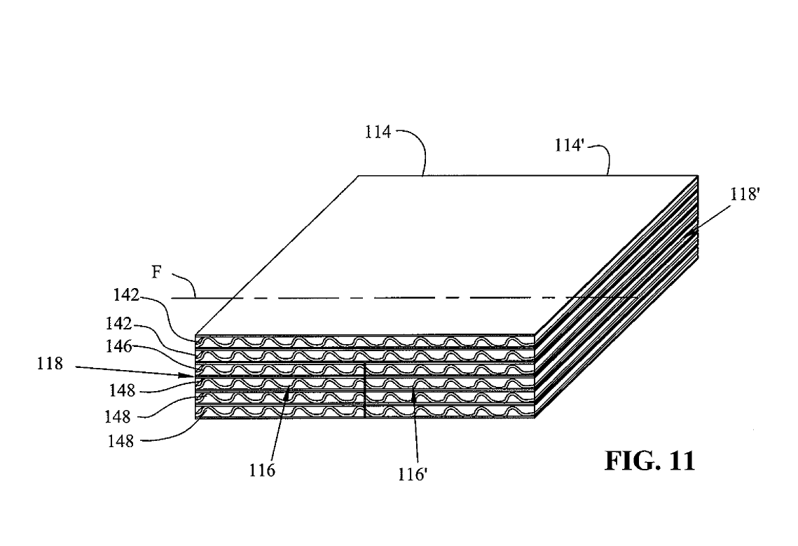

As shown in FIG. 11, in the depicted embodiment of the invention, a final cut made along the line indicated by “F” extends through at least one lower sheet 142 and may extend into a sufficient number of additional sheets 142, 146, 148 as necessary. The depth of the cut made along line “F” may be any depth suitable for the usage of the member 100. In addition, the thickness of the cut “F” should be suitable for the usage of the protective member 100. In the depicted embodiment of the invention, the cut “F” is orientated perpendicular to the cut “E” and completes the assembly of the member 100.

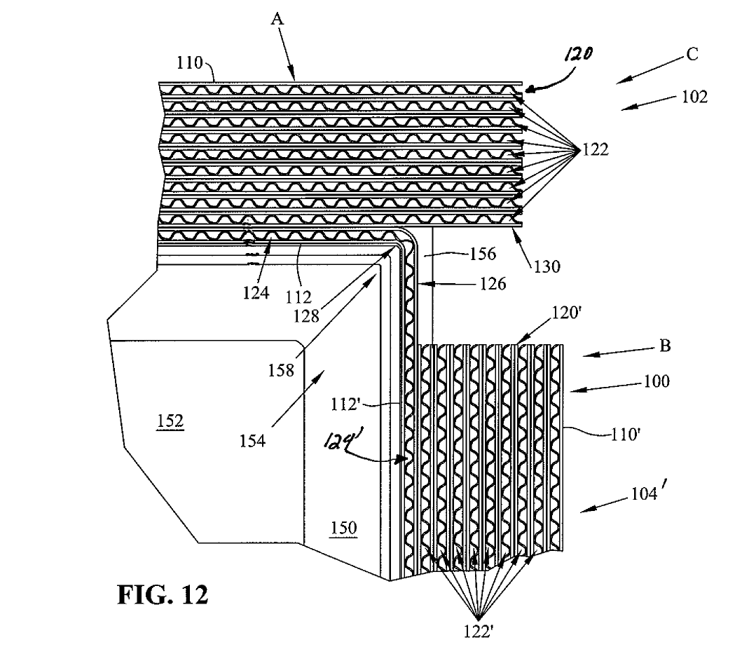

Now that the assembly of protective member 100 has been described, an example of the utilization of a protective member 100 will be described in detail with reference to FIG. 12. In the depicted embodiment of the invention, the protective member 100 protects a window 150. Window 150 includes a glass portion 152 encompassed by a frame 154. Frame 154 includes a flange 156 integrally formed in the frame 154. In the depicted configuration, frame 154 includes four corners, each indicated by numeral 158.

Protective member 100 is configured to protect the flange 156 at the corner 158 of frame 154. Protective member 100 protects flange 156 by locating flange 156 within slot 132. When member 100 is properly positioned on window 150, the second portion 104 is positioned along a substantially straight portion of frame 154 proximate one of the corners 158 of the window 150. Similarly, a majority of first portion 102 is connected to a straight portion of frame 154 located opposite the corner 158. This interconnection may be achieved by locating a portion of flange 156 within the slot 132 of first portion 102. It should be noted that free portion 126 of base sheet 124 of first portion 102 is connected to the portion of the frame 154 to which the second portion 104 is coupled. When member 100 is properly positioned in the depicted embodiment, bend 128 should align with corner 158.

In the depicted embodiment of the invention, once the protective member 100 has been properly positioned with respect to the corner 158 of frame 154, the free portion 130 of the upper sheets 122 extends beyond the corner 158. In this manner, the free portion 130 protects the corner 158. Specifically, the protective member 100 of the depicted invention provides protection from a force in the direction of arrow “A” with the force absorbing capability of the upper sheets 122 of first portion 102. Similarly, the force absorbing capabilities of the upper sheets 122′ of second portion 104 prevents forces in the direction of arrow “B” from damaging the frame 154. Furthermore, the free portion 130 of the upper sheets 122 of first portion 102 absorbs forces in the direction of arrow “C”, thereby preventing these forces from damaging the frame 154. Accordingly, the protective member 100 protects the corner 158 of the frame 154, including the flange 156. In addition, the protective member 100 of the present invention provides the advantage that the bend 128 in the first portion 102 may be moved in position, so as to allow more or less of the free portion 130 of the upper sheets 122 to extend beyond corner 158 as necessary for any particular application.

While this invention has been described as having an exemplary design, the present invention may be further modified within the spirit and scope of this disclosure. The application is intended, therefore, to cover any variations, uses, or adaptations of the invention using its general principles. Further, this application is intended to cover such departures from the present disclosure as come within known or customary practice in the art to which this invention pertains.

What is claimed is:

1. A member for protecting a corner of a window having a frame including:
a first portion including a plurality of sheets, the first portion connected to a first side of a frame; and
a second portion including a plurality of sheets, the second portion being interconnected to the first portion by an intermediate member and connected to a second side of a frame;
wherein a portion of the sheets of the first portion overlaps a portion of the second portion.

2. The member for protecting a corner of a window having a frame as set forth in claim 1 wherein the sheets are corrugated sheets.

3. The member for protecting a corner of a window having a frame as set forth in claim 2 wherein the corrugated sheets are manufactured from paper.

4. The member for protecting a corner of a window having a frame as set forth in claim 2 wherein the corrugated sheets are manufactured from plastic.

5. The member for protecting a corner of a window having a frame as set forth in claim 1 further including a slot capable of receiving a flange integral with the frame.

6. The member for protecting a corner of a window having a frame as set forth in claim 1 wherein the sheet includes a bend defining a free portion of the first portion, the free portion of the first portion overlapping the second portion.

7. A method of manufacturing a protective member comprising the steps of:
affixing a plurality of corrugated sheets together to form an upper section;
affixing at least one lower sheet to the upper section in a manner ensuring a central portion of the lower sheet is free from a central portion of the upper section; and
cutting the upper section at a location positioned at substantially the center of the central portion.

8. The method as set forth in claim 7 further comprising the step of cutting a slot in the underside of the at least one lower sheet.

9. The method as set forth in claim 8 wherein the slot extends into the upper section.

10. The method as set forth in claim 9 further comprising the steps of:
cutting the upper section and the at least one lower sheet in a manner forming a first side;
cutting the upper section and the at least one lower sheet in a manner forming a second side;
cutting the upper section and the at least one lower sheet in a manner forming a first outside face; and
cutting the upper section and the at least one lower sheet in a manner forming a second outside face.

11. The method as set forth in claim 7 further comprising the step of bending the lower sheet at a position proximate the edge of the central portion.

12. The method as set forth in claim 7 wherein the corrugated sheets are manufactured from paper.

13. The method as set forth in claim 7 wherein the corrugated sheets are manufactured from plastic.
